(19) United States
(12) Patent Application Publication
(10) Pub. No.: US 2003/0015482 A1
(43) Pub. Date: Jan. 23, 2003

(54) Double filtration for purifying coolant-lubricant liquids

(76) Inventor: Karl-Guenter Bremer, Eschweiler (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/106,877

(22) Filed: Mar. 27, 2002

Related U.S. Application Data
(63) Continuation of application No. PCT/EP00/08535, filed on Sep. 1, 2000.

(30) Foreign Application Priority Data
Sep. 28, 1999 (DE) 199 46 391.3

(51) Int. Cl. B01D 37/00

(52) U.S. Cl. 210/790

(57) ABSTRACT

A method for purifying coolant-lubricant oils which continuously circulate in metalworking installations and are purified by a vacuum filter assembly (13). The basic filtration takes place in the main stream, while additional purification by membrane filtration takes place in a secondary stream. The resulting method has a high filtration capacity and ensures an optimal purification of the coolant-lubricant liquid.

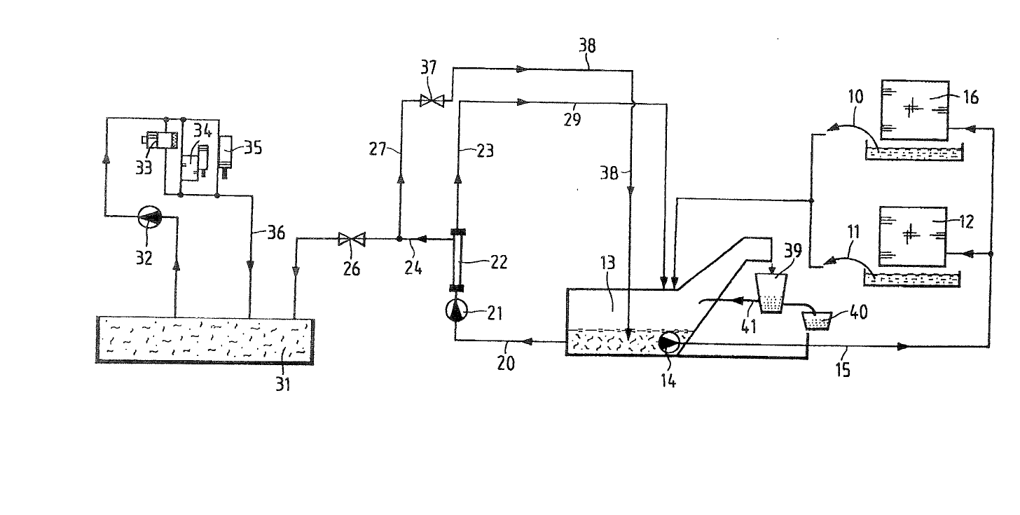

### CROSS REFERENCE TO RELATED APPLICATIONS

This application is a continuation of international patent application no. PCT/EP00/08535, filed Sep. 1, 2000, designating the United States of America, the entire disclosure of which is incorporated herein by reference. Priority is claimed based on Federal Republic of Germany patent application no. DE 199 46 391.3, filed Sep. 28, 1999.

### BACKGROUND OF THE INVENTION

The invention relates to a method for purifying coolant lubricants which circulate continuously in metal-working facilities.

Liquid coolant-lubricants formed from emulsions or oils are used in metal-working facilities primarily for cooling and lubrication of interfaces and for carrying off the abraded particles which arise. The coolant-lubricant is in continuous circulation. To supply multiple or individual metal-working machines, the coolant-lubricant is redelivered to the individual machines via a centralized or decentralized supply unit. As the result of more demanding requirements in newer production areas, such as surface qualities or tool service life, oil is increasingly used more often than emulsions as a coolant-lubricant.

Belt filter units which operate in a vacuum or subatmospheric pressure system are suitable for filtering oil. A belt filter unit of this type is known, for example, from published European patent application no. EP 228,210. These belt filter units have a very high contaminant filtration capacity and are able to effectively filter dirt particles from the oil up to a certain filtration limit.

It is also known to use cross-flow microfilters in the filtration of media in the metal-working industry (Fertigungstechnik [Production Technology] Volume 96.10, 1996, pp. 53-71). This has proven to be an efficient and qualitatively superior purification method for process liquids. The filtration method is based on microfiltration membranes, preferably in the form of a tube or capillary, with pore sizes ranging from 0.05 μm to 0.4 μm.

In a manner similar to ultrafiltration, the process solution or liquid to be purified is conducted through the membrane tube or capillary. Under the influence of the applied transmembrane pressure, clear filtrate passes through the microporous membrane, while all suspended or emulsified particles larger than the corresponding pore size are held back and concentrated. Bacteria also may be reliably separated, while substantially all dissolved components are able to pass unhindered through the membrane. It is thus possible to effectively separate undissolved and dissolved valuable substances. Using this technique, solids can be completely removed from the liquids arising in grinding, polishing, or other metal-working operations.

A disadvantage of this type of filtration lies in the fact that the filtration capacity is very low, and this technique thus is suitable only for filtering small amounts of liquid.

### SUMMARY OF THE INVENTION

The object of the invention is to provide a method for purifying coolant-lubricants which has a high filtration capacity and at the same time assures optimal purification of the liquid.

This and other objects are achieved by the invention as described and claimed hereinafter.

A substantial advantage of the invention lies in the fact that filtration occurs in both main and secondary streams. A filter web of nonwoven fabric or the like in the main stream provides for a high filtration capacity, while membrane filtration in the secondary stream achieves the highest possible purity of the filtered oil.

According to one preferred embodiment of this invention, the filtered oil produced in the secondary stream can be delivered to the hydraulic oil supply of the machine tool. This oil can be used both for initial filling and for make-up or refilling of the hydraulic oil supply.

Another preferred embodiment of the invention envisions connecting both oil circuits in processing machines, thereby creating a common oil circuit. This connection has significant economic advantages. Thus, a single filter system may be used for two or more oil circuits.

A further embodiment of the invention provides for continuously or discontinuously supplying the hydraulic oil circuit with ultrapure oil. It is advantageous to provide an ultrapure oil container which may be filled with oil as needed.

A supplemental aspect of the invention involves the use of a precoated filter or an addition of cellulosic filtering aid. In addition, it is possible to provide cross-flow ultrafiltration. In both precoated filters and the use of added cellulosic filtering aid material, a filter aid is applied to the filter element, i. e., on top of the filter web, thereby improving the filtering effect.

Because oils have an affinity for fine-particle contaminants produced in the metal cutting production process, ultrafine filtration facilities are necessary. Precoated filtration units are suitable for maintenance filtration, preferably coated with a layer of fullers earth (also known as bleaching clay) having an average particle size of less than 0.06 mm. Other known precoated filters which may be used include systems which utilize intrinsically deposited dirt layers to enhance the filtration. However, this method must be coupled with other methods such as secondary stream filtration, for example.

A further embodiment of the invention provides for dewatering or deliquifying the accumulated dirt residues collected by the filter unit by using a centrifuge. The liquid purified by the centrifuge is returned to the filtration circuit. The compacted dirt can be continuously or discontinuously discharged. The filtering systems may be supplemented by settling tanks or sedimentation units, magnetic separators, or filters of any desired type of construction which free the liquid from the solid constituents.

Another advantage of the described method lies in the fact

that oil leaks, for example oil leaks in the machine tool hydraulic system, no longer have unfavorable effects on the different oil circuits, since this so-called leakage oil can be returned to the common circuit and purified there. This connected system has the specific advantage that amounts of leaking oil can be planned in the design of the hydraulic system, whereby the even greater resultant oil loss is intentionally used to reduce the frictional wear in seals, etc. The frictional wear may thus be reduced, resulting in increased efficiency of the hydraulic system and a noticeable reduction in introduced heat. At the same time, a further reduction of various hydraulic system components and general optimization in the hydraulic area are achieved. In addition, the waste disposal costs are decreased as the result of the fact that little or no amounts of residual oil are generated.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWING

The invention will be described in further detail hereinafter with reference to an illustrative preferred embodiment shown in the accompanying drawing FIGURE, which is a schematic representation of the linkage of a hydraulic oil circuit with a coolant-lubricant oil circuit.

### DETAILED DESCRIPTION OF PREFERRED EMBODIMENTS

The coolant-lubricant, generated from the machine tools 16, 12 in metal cutting operations and loaded with metal shavings and impurities, is delivered via lines 10, 11 to a vacuum belt filter 13. A continuous filter web is provided in the vacuum belt filter 13. The liquid that is purified there is conveyed via the pump 14 and lines 15 back to the machine tools 12, 16. A portion of the oil purified in the vacuum filter which has already been purified with a filter fineness of approximately 20 μm to 30 μm is delivered via the line 20 and a pump 21 to a cross-flow filter membrane 22. This cross-flow filter membrane separates oil with a high purity. This oil is conducted via the lines 24 and valve 26 to a high purity oil container for the hydraulic oil circuit. This high purity oil container 31 may be provided with an automatic level control. Thus, hydraulic oil is refilled when the container level falls below a specified amount. From this high purity oil container 31, the oil is conveyed to the hydraulic oil circuit. This hydraulic oil circuit is schematically represented only by a pump 32 and various oil consuming devices 33, 34, 35. From the oil consuming devices, the oil is conducted via the line 36 back to the highly pure oil tank 31. It is understood that these oil consuming devices 33 through 35 are situated in the machine tools 12, 16 or in peripheral, hydraulically driven machines.

The unpurified oil or concentrated oil which is passed through the cross-flow filter membrane 22 is delivered via the lines 23 and return flow 29 to the dirty side of the low-pressure filter 13. If no oil is required in the hydraulic oil circuit, the ultrapure oil produced by the cross-flow filter membrane 22 can be conducted via the secondary stream line 27 and the valve 37 and line 38 to the highly purified oil region of the vacuum filter 13. This secondary stream thus contributes to the improvement of oil quality in the coolant-lubricant circuit. In this manner, the coolant-lubricant circuit pumped through the machine tool is continuously mixed with the ultrafine filtrate as well, with the result that the oil quality is also markedly improved in the coolant-lubricant circuit, and the service life of the machine tools is distinctly improved.

As shown in the FIGURE, the described oil linkage unit is designed as a coolant-lubricant filter unit that is supplemented with a maintenance or polish filter device which comprises a cross-flow membrane filter. The dirt discharged from the vacuum filter 13 is delivered to a centrifuge 39, is deliquified there, and is then conveyed to waste disposal via a container 40. The liquid exiting the centrifuge is conducted via the line 41 into the unfiltered liquid region of the vacuum filter 13.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations falling within the scope of the appended claims and equivalents thereof.

What is claimed is:

1. A method for purifying coolant-lubricants which circulate continuously in metal-working facilities, using filtration units arranged in a circuit, with filtration taking place in main and secondary streams, and with a filter web filter disposed in the main stream and a membrane filter disposed in the secondary stream, wherein the oil purified by the membrane filter is delivered to a hydraulic oil supply and/or the secondary stream of the coolant-lubricant supply.

2. A method according to claim 1, wherein the filter web filter is a vacuum belt filter.

3. A method according to claim 1, wherein the membrane filter is a cross-flow ultrafiltration membrane filter.

4. A method according to claim 1, wherein a coolant-lubricant circuit and a hydraulic oil circuit are connected in a common circuit.

5. A method according to claim 1, further comprising filling a hydraulic oil circuit with highly pure oil from the membrane filter.

6. A method according to claim 1, wherein the membrane filter is operated discontinuously.

7. A method according to claim 1, wherein the membrane filter is operated continuously.

8. A method according to claim 1, wherein the filtration of the main stream is enhanced by precoating the filter web with a layer of a filtering aid.

9. A method according to claim 1, wherein the filtration of the main stream is enhanced by injecting a filtering aid into the coolant-lubricant prior to filtration.

10. A method according to claim 9, wherein said filtering aid comprises cellulose.

11. A method according to claim 1, further comprising deliquifying solid residues collected by the belt filter in a centrifuge.

12. A method according to claim 1, wherein an intermediate container is provided between the filter web filter and the membrane filter.
